(19) United States
(12) Patent Application Publication
(10) Pub. No.: US 2023/0142256 A1
(43) Pub. Date: May 11, 2023

(54) Method of Selecting Solvent for Polymer and Composition Containing Selected Solvent

(71) Applicants: SK Innovation Co., Ltd., Seoul (KR); SK ie technology Co., Ltd., Seoul (KR)

(72) Inventors: Chang Q Lee, Daejeon (KR); Seung Min Jeon, Daejeon (KR)

(21) Appl. No.: 17/976,352

(22) Filed: Oct. 28, 2022

(30) Foreign Application Priority Data
Oct. 30, 2021 (KR) 10-2021-0147492

(51) Int. Cl. C08L 77/10; C08G 69/26; C08J 3/11; C08J 5/18

(52) U.S. Cl. CPC C08L 77/10; C08G 69/265; C08J 3/11; C08J 5/18; C08L 2201/10; C08L 2203/16

(57) ABSTRACT

The present disclosure relates to a method of selecting a polymer solution (also referred to as a “dope solution”) that is prepared by dissolving a polymer in a solvent in order to cast a film and may provide excellent optical and mechanical properties of the film, a polymer solution prepared using the selected solvent, and a film produced using the polymer solution. In addition, one embodiment is to provide a method of selecting a solvent for a polyamideimide-based or polyimide-based polymer for providing a polymer solution (dope solution) that may provide excellent optical properties of a film and may provide excellent physical properties of a film for an optical device or a display device by improving long-term storage stability of the polymer solution for producing a film.

### CROSS-REFERENCE TO RELATED APPLICATION

This application claims priority to Korean Patent Application No. 10-2021-0147492, filed Oct. 30, 2021, the disclosure of which is hereby incorporated by reference in its entirety.

### BACKGROUND OF THE INVENTION

### Field of the Invention

The following disclosure relates to a polymer solution (also referred to as a “dope solution”) that may provide physical properties of a film in order to not only increase a polymerization yield by selecting an appropriate solvent used for polymerization of a polymer but also to cast the film by dissolving the polymerized polymer in the selected solvent. More particularly, the following disclosure relates to a method of selecting a solvent for a dope solution that may provide excellent optical and mechanical properties of a film, a polymer solution prepared using the selected solvent, and a film produced using the polymer solution.

In addition, one embodiment is to improve long-term storage stability of the polymer solution (dope solution) for producing a film that may provide excellent optical properties of the film. In addition, one embodiment is to provide a method of preparing a composition, the method comprising selecting a solvent for a polyamideimide-based or polyimide-based polymer for providing a polymer solution that may provide excellent physical properties of a film for an optical device or a display device, and a composition.

### Description of Related Art

In the use of a solution containing a polymer, in particular, in optical fields such as an optical film, a method of selecting a solvent is significantly important because it has a sensitive effect on optical properties of the optical film.

A swelling and dissolution process of the polymer is understood by selecting a solvent, such that it is easy to design a polymer and set processing conditions, and it is easy to select a suitable solvent.

Therefore, the swelling and dissolution process has been recognized as an important phenomenon ranging from coating, semiconductor packaging, film separation, microlithography, a drug delivery material, and tissue engineering using a polymer solution, and a method of selecting a solvent that affects these processes has been constantly studied as a research subject.

That is, differences in optical and mechanical properties caused by differences in structural and chemical properties of the polymer itself occur, and even in a case of the same polymers, differences in optical and mechanical properties depending on a solvent used in a dope solution occur. Therefore, a method of selecting a solvent is significantly important to solve this problem.

That is, selection of a solvent in the above field and the like using a polymer solution is related to physical properties such as surface tension, wettability, a ratio of coefficient of thermal expansion/coefficient of compressibility, a boiling point of a non-polar solvent, and a glass transition temperature of a polymer. Therefore, research on the interaction between the physical properties and solubility of the polymer has been conducted for a long time.

As an example of such research, Korean Patent Laid-Open Publication No. 10-2020-0141307 discloses a method of predicting solubility using Hansen solubility parameters. However, the method using the Hansen solubility parameters, which is a thermodynamic approach, is based on a simple methodology that ignores a specific interaction between molecules, and has a problem in that the interaction between molecules is inaccurate.

Meanwhile, in Korean Patent Laid-Open Publication No. 10-2020-0018129, since a value obtained by calculating mixing energy of a solute to a solvent varies depending on compositions of a solvent, a polymer, and a binder, the compositions are required to be specified and difficult to be generalized. In addition, the effect of changing the interaction with the solvent according to a molecular weight distribution of the polymer is not considered.

### SUMMARY OF THE INVENTION

An embodiment of the present disclosure is directed to providing a method of selecting a polymer solution (also referred to as a “dope solution”) prepared by dissolving a polymer in a solvent in order to cast a film. That is, the present disclosure relates to a method of selecting a solvent for a dope solution (having the same meaning as a polymer solution) that may provide excellent optical and mechanical properties of a film, a polymer solution prepared using the selected solvent, and a film produced using the polymer solution.

Another embodiment of the present disclosure is directed to providing a method of selecting a solvent for a polyamideimide-based or polyimide-based polymer, a composition containing the selected solvent, a polyamideimide-based or polyimide-based film that is produced using the composition and has a low haze and excellent long-term storage stability, in particular, a transparent film, and a method of producing the polyamideimide-based or polyimide-based film.

Still another embodiment of the present disclosure is directed to providing a polymer solution (also referred to as a “dope solution”) that may provide excellent optical properties of a film and may provide excellent physical properties of a film for an optical device or a display device by improving long-term storage stability of the polymer solution (dope solution). Still another embodiment of the present disclosure is directed to providing a method of selecting a polymerization solvent for a polyamideimide-based or polyimide-based polymer.

Still another embodiment of the present disclosure is directed to providing a method of selecting a polymerization solvent for providing a transparent film that has excellent physical properties and is formed of a polyamideimide-based or polyimide-based polymer, and a transparent film having excellent optical properties by predicting miscibility of the selected solvent using the method and the polymer.

One embodiment relates to a method of preparing a composition for producing a transparent film and a composition for producing a transparent film.

In one general aspect, a method of preparing a composition for producing a transparent film that contains a polymer, and a polymerization solvent for the polymer comprises selecting a polymerization solvent for the polymer, wherein the selecting of the polymerization solvent may satisfy all of the following conditions (1) to (4): (1) the polymerization solvent for the polymer is selected by the following [Equation 1], (2) an amide bond ratio in [Equation 1] is less than 1.0, (3) the solvent selected in (1) has a value that is calculated by [Equation 1] and is equal to or greater than a reference value, and (4) the reference value is a value of [Equation 1] when DMAc is used as the polymerization solvent of the polymer,

$$\left(△ △ μ\right) * / \left(\text{amide bond ratio}\right) = \left\{\left(△ △ {μ}_{\text{ir}}\right) / △ \text{r}\right\} * .$$

In [Equation 1], Δµ is a difference in pseudo-chemical potential of the polymer dissolved in the solvent. As the solubility is higher, Δµ has a greater value. Δµᵢᵣ means Δµ of a polymer i having an amide bond ratio r, and a unit thereof is kcal/mol. Δr means a difference in amide bond ratio between two or more kinds of amide bonds, (ΔΔµᵢᵣ)/Δr means ΔΔµᵢᵣ which is a difference in Δµᵢᵣ according to the difference in amide bond ratio, and { (ΔΔµᵢᵣ)/Δr}* is a standardized value of (ΔΔµᵢᵣ)/Δr. { (ΔΔµᵢᵣ)/Δr}* may be calculated as follows.

$$\left\{\left(△ △ {μ}_{\text{ir}}\right) / △ \text{r}\right\} * = \left[\left\{\left(△ △ {μ}_{\text{ir}}\right) / △ \text{r}\right\} - {\text{m}}_{\text{ir}}\right] / {\text{σ}}_{\text{ir}}$$

In [Equation 1–1], mᵢᵣ means an average of (ΔΔµᵢᵣ)/Δr, and σᵢᵣ means a standard deviation of (ΔΔµᵢᵣ)/Δr. In [Equation 1], when describing Δµ in more detail, in Δµᵢ* = (µᵢ^{pure} – µᵢ^{solv})∗, µi^{pure} means a pseudo-chemical potential of the polymer i, and µᵢ^{solv} means a pseudo-chemical potential of the polymer i dissolved in the solvent. A difference between µᵢ^{pure} and µᵢ^{solv} is Δµᵢ, and Δµᵢ* is a standardized value of Δµᵢ. The standardized value Δµᵢ* is calculated as follows.

$$△ {μ}_{\text{i}} * = \left(△ {μ}_{\text{i}} - {\text{m}}_{\text{i}}\right) / {\text{σ}}_{\text{i}}$$

In [Equation 1–2], mi means an average of Δµᵢ, and σᵢ means a standard deviation of Δµᵢ. In [Equation 1], Δµ is a value calculated using the COSMO-RS theory.

In another general aspect, a composition for producing a transparent film contains: a polymer; and a polymerization solvent for the polymer, wherein the polymerization solvent may satisfy all of the following conditions (1) to (4): (1) the polymerization solvent for the polymer is selected by the following [Equation 1], (2) an amide bond ratio in [Equation 1] is less than 1.0, (3) the solvent selected in (1) has a value that is calculated by [Equation 1] and is equal to or greater than a reference value, and (4) the reference value is a value of [Equation 1] when DMAc is used as the polymerization solvent of the polymer,

$$\left(△ △ μ\right) * / \left(\text{amide bond ratio}\right) = \left\{\left(△ △ {μ}_{\text{ir}}\right) / △ \text{r}\right\} * .$$

In [Equation 1], Δµ is a difference in pseudo-chemical potential of the polymer dissolved in the solvent. Δµᵢᵣ means Δµ of a polymer i having an amide bond ratio r, Δr means a difference in amide bond ratio between two or more kinds of amide bonds, (ΔΔµᵢᵣ) /Δr means ΔΔµᵢᵣ which is a difference in Δµᵢᵣ according to the difference in amide bond ratio, and { (ΔΔµᵢᵣ) /Δr}* is a standardized value of (ΔΔµᵢᵣ) /Δr. In [Equation 1], Δµ is a value calculated using the COSMO-RS theory.

The polymer may be a polyamideimide-based or polyimide-based polymer.

The polymer may have a structural unit derived from one or two or more selected from the group consisting of an aromatic diamine, a dianhydride, and an aromatic diacid dichloride. The aromatic diamine may comprise 2,2′-bis(trifluoromethyl)benzidine. The dianhydride may comprise an aromatic dianhydride and an alicyclic dianhydride.

The aromatic diacid dichloride may be one or a mixture of two or more selected from the group consisting of terephthaloyl dichloride, isophthaloyl dichloride, 1,1′-biphenyl-4,4′-dicarbonyl dichloride, 1,4-naphthalenedicarboxylic dichloride, 2,6-naphthalenedicarboxylic dichloride, and 1,5-naphthalenedicarboxylic dichloride.

In still another general aspect, there is provided a transparent film produced using the composition for producing a transparent film. In still another general aspect, a window cover film comprises the transparent film. In still another general aspect, a display device comprises the window cover film.

Other features and aspects will be apparent from the following detailed description, the drawings, and the claims.

### BRIEF DESCRIPTION OF THE DRAWING

FIG. 1 is a graph showing a correlation between an amide bond ratio r and Δuᵢᵣ, in which the graph is an exemplary graph showing a correlation between an amide bond ratio r and Δµᵢᵣ when 11 kinds of solvents are selected from 1,400 kinds of solvents, and [Equation 1], which is a predicted value of solubility of the 11 kinds of solvents for a polyamide oligomer of one embodiment, is calculated, the slope of the straight line indicates (ΔΔµᵢᵣ)/Δr, and when DMAc is used, a value of (ΔΔµᵢᵣ)/Δr is 47.912, and a standardized value according to standardization (calculated into an average value and a standard deviation value of 1,400 kinds of solvents) represented in [Equation 1] is 1.84.

### DESCRIPTION OF THE INVENTION

Unless otherwise defined, all the technical terms and scientific terms used herein have the same meanings as commonly understood by those skilled in the art disclosed herein. The terms used herein are merely used to effectively describe a specific embodiment, but are not intended to limit the present disclosure.

Unless the context clearly indicates otherwise, the singular forms used herein may be intended to comprise the plural forms.

In the present specification, the expression “comprise(s)” is intended to be an open-ended transitional phrase having an equivalent meaning to “comprise(s),” “contain(s),” “have (has),” and “are (is) characterized by,” and does not exclude elements, materials, or steps, all of which are not further recited herein.

In the present specification, the term “a combination thereof” may mean mixing or copolymerization of components.

In the present specification, the term “polymer” may refer to a molecule having a relatively high molecular weight, and a structure thereof may comprise multiple repeats of units derived from a molecule having a low molecular weight. In one embodiment, the polymer may be an alternating copolymer, a block copolymer, a random copolymer, a graft copolymer, a gradient copolymer, a branched copolymer, a crosslinked copolymer, or a copolymer comprising all of these copolymers (for example, a polymer containing more than one kind of monomers). In another embodiment, the polymer may be a homopolymer (for example, a polymer containing one kind of monomers).

In the present specification, the term “polyimide” may be used to comprise polyimide or polyamideimide.

In order for a polyamideimide film to be applied to a display device, a specific yellow index of the polyamideimide film should be improved, colorless and transparent performance should be secured, and mechanical properties should be also improved. However, in a case where a compound having a rigid structure or an amide group is introduced to improve mechanical properties of colorless polyamideimide (CPI), there is a problem in that optical properties are deteriorated even though the mechanical properties are improved. In addition, the handleability of the solution is deteriorated and the difficulty of the process is increased, and thus, there may be a limit in obtaining a film using the resin. Moreover, in the case of the polymer, significant differences in optical properties depending on a solvent may occur. In addition, in a case where a difference between casting times occurs after a polymer solution (dope solution) is prepared by dissolving a polymer in a solvent, differences in physical properties of a film to be produced occur.

That is, differences in optical and mechanical properties caused by differences in structural and chemical properties of the polymer itself occur, and even in a case of the same polymers, differences in optical and mechanical properties depending on a solvent used in a dope solution occur over time. Therefore, a method of selecting a solvent is significantly important to solve this problem.

Accordingly, attempts have been actively made to obtain a novel dope solution for a polyamideimide-based resin that may simultaneously provide excellent mechanical and optical properties to a polyamideimide film and has excellent handleability.

In order to achieve the above object, the present disclosure provides a method of selecting a polymerization solvent by applying an algorithm regarding a predicted value of solubility of a polymer represented by the following [Equation 1] using the COSMO-RS module comprised in Amsterdam Modeling Suite manufactured by SCM.

In one embodiment, a method of selecting a polymerization solvent from the predicted value of solubility of a polyamideimide-based or polyimide-based polymer represented by [Equation 1] is provided:

$$\left(△ △ μ\right) * / \left(\text{amide bond ratio}\right) = \left\{\left(△ △ {μ}_{\text{ir}}\right) / △ \text{r}\right\} * .$$

In [Equation 1], Δµ is a difference in pseudo-chemical potential of the polymer dissolved in the solvent. As the solubility is higher, Δµ has a greater value. Δµᵢᵣ means Δµ of a polymer i having an amide bond ratio r, and a unit thereof is kcal/mol. ΔΔµ means a difference in Δµ. Δµ* is a standardized value of Δµ, and (ΔΔµ)* is a standardized value of ΔΔµ. Δr means a difference in amide bond ratio between two or more kinds of amide bonds, (ΔΔµᵢᵣ)/Δr means ΔΔµᵢᵣ which is a difference in Δµᵢᵣ according to the difference in amide bond ratio, and { (ΔΔµᵢᵣ)/Δr} * is a standardized value of (ΔΔµᵢᵣ)/Δr. { (ΔΔµᵢᵣ)/Δr} * may be calculated as follows.

$$\left\{\left(△ △ {μ}_{\text{ir}}\right) / △ \text{r}\right\} * = \left[\left\{\left(△ △ {μ}_{\text{ir}}\right) / △ \text{r}\right\} - {\text{m}}_{\text{ir}}\right] / {\text{σ}}_{\text{ir}}$$

In [Equation 1–1], mᵢᵣ means an average of (ΔΔµᵢᵣ)/Δr, and σᵢᵣ means a standard deviation of (ΔΔµᵢᵣ)/Δr.

In [Equation 1], when describing Δµ in more detail, in Δµᵢ* = (µᵢ^{pure} – µᵢ^{solv})*, uᵢ^{pure} means a pseudo–chemical potential of the polymer i, and µᵢ^{solv} means a pseudo–chemical potential of the polymer i dissolved in the solvent.

A difference between µᵢ^{pure} and µᵢ^{solv} is Δµᵢ, and Δµᵢ* is a standardized value of Δµi.

The standardized value Δµᵢ* is calculated as follows.

$$△ {μ}_{\text{i}} * = \left(△ {μ}_{\text{i}} - {\text{m}}_{\text{i}}\right) / {\text{σ}}_{\text{i}}$$

In [Equation 1–2], mi means an average of Δµᵢ, and σᵢ means a standard deviation of Δµᵢ. In [Equation 1], Δµ is a value calculated using the COSMO-RS theory.

The pseudo-chemical potential of the polymer may be calculated using a UNIFAC, UNIQUAC, or QSPR-based methodology.

The software used to calculate the pseudo-chemical potential of the polymer is the COSMO–RS module comprised in Amsterdam Modeling Suite manufactured by SCM. For more detailed contents, https://www.scm.com/product/cosmo-rs/ may be referred to, and the detailed theory related thereto is well known, such as that disclosed in 2011 John Willey & Sons, Ltd. WIREs Comput Mol Sci 2011 1 699-709 DOI: 10.1002/wcms.56.

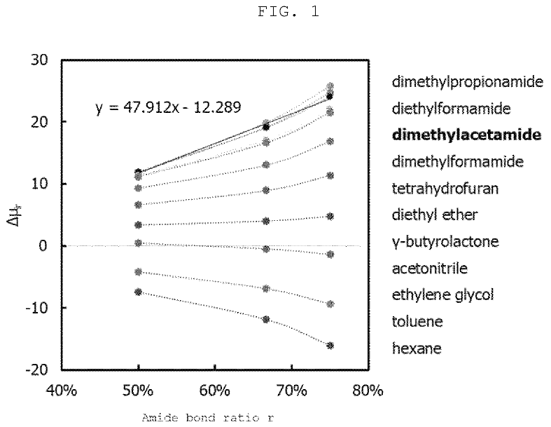

First, about 2,300 kinds of solvents are selected, and values of pseudo-chemical potential (Δµ) are calculated using the COSMO-RS theory. Melting point (mp) and boiling point (bp) values of the 2,300 kinds of solvents are calculated, and 1,400 kinds of solvents estimated to exist as liquids at room temperature are selected. In this case, an average value of (ΔΔµᵢᵣ) /Δr and a standard deviation value of the 1,400 kinds of the solvents are -1.159 and 26.62, respectively. The slope of the straight line in FIG. 1 is expressed as (ΔΔµᵢᵣ) /Δr, and is normalized to a value of (ΔΔµᵢᵣ)/Δr of a specific solvent and the average value and the standard deviation value of the 1,400 kinds of solvents.

In [Equation 1], the amide bond ratio means a ratio of the number of amide bonds to the total number of bonds between monomers containing a terminal amine group or a terminal carbonyl group. As the oligomer chain lengthens, the amide bond ratio is also increased. In [Equation 1], the amide bond ratio may be less than 1.0. More preferably, the amide bond ratio may be less than 0.9. When the amide bond ratio is 0.8 or less, it is most preferable to achieve the object of one embodiment. When the amide bond ratio satisfies the above value, a solvent suitable for polymerization may be accurately selected.

In one embodiment, when a value of (ΔΔµ)*/(amide bond ratio) = { (ΔΔµᵢᵣ) /Δr}* of each of the solvents is measured using a polymer of Example 1, the value may be in a range of 1.0 to 4.0. In addition, in one embodiment, in a case of a composition containing a solvent satisfying a value of (ΔΔµ) */(amide bond ratio) = {(ΔΔuᵢᵣ)/Δr}* of 1.8 or more, for example, 1.8 or more and 4.0 or less, and a polymer, long-term storage stability is excellent, such that transparency of the polymer solution is not reduced due to long-term storage, transportation, or the like, and optical properties of an optical film or the like produced using the composition may be significantly excellent. That is, by searching for a solvent in which (ΔΔµ)*/(amide bond ratio) is greater than a specific value of 1.8 or more, the polymerizable monomer of the polymer of one embodiment is well dissolved, and the polymer is well dissolved, such that a polymer capable of producing a film having excellent transparency may be prepared. By the method of selecting a polymerization solvent for a polymer, an appropriate solvent may be selected according to use and properties of a desired composition. The polymer that may be used in the composition of one embodiment may be, in particular, a polyamideimide-based polymer.

Hereinafter, the solvent selection in one embodiment will be described as follows by taking the value of (ΔΔµ)*/(amide bond ratio) = { (ΔΔµᵢᵣ)/Δr}* of one embodiment calculated using the polyamideimide-based polymer of Example 1 as an example. First, the value of (ΔΔµ)*/(amide bond ratio) = { (ΔΔµᵢᵣ)/Δr} * calculated using the polyamideimide-based polymer of Example 1 is shown in Table 1.

TABLE 1

| Solvent | Δµᵢᵣ | | | (ΔΔµ)*/(amide bond ratio) |
|---|---|---|---|---|
| | r = 0.5 | r = 0.667 | r = 0.75 | |
| Hexane | -7.43 | -11.85 | -16.03 | -1.20 |
| Toluene | -4.18 | -6.89 | -9.37 | -0.71 |
| Dichloromethane | -3.17 | -5.20 | -7.04 | -0.52 |
| Ethylene glycol | 0.40 | -0.51 | -1.37 | -0.21 |
| Acetonitrile | 3.36 | 4.01 | 4.79 | 0.25 |
| Methanol | 4.31 | 5.57 | 6.91 | 0.42 |
| Butyl acetate | 5.30 | 7.19 | 9.22 | 0.61 |
| y-Butyrolactone | 6.58 | 8.91 | 11.38 | 0.74 |
| Methyl isobutyl ketone | 7.91 | 11.03 | 14.25 | 0.96 |
| Diethyl ether | 9.34 | 13.06 | 16.86 | 1.13 |
| Tetrahydrofuran | 11.16 | 16.64 | 21.51 | 1.55 |
| Dimethylformamide | 11.37 | 17.11 | 22.08 | 1.61 |
| Dimethylacetamide | 11.86 | 19.06 | 24.04 | 1.84 |
| Diethylformamide | 11.89 | 19.15 | 24.72 | 1.93 |
| Dimethylpropionamide | 11.92 | 19.91 | 25.76 | 2.08 |

A polyamideimide resin of one embodiment for the solvent selection is not limited, but examples thereof are as follows. The polymer may provide a polymer and composition having a structural unit derived from an aromatic diamine, a dianhydride, and/or an aromatic diacid dichloride. The aromatic diamine may provide a polymer and composition containing 2,2′-bis(trifluoromethyl)benzidine. The dianhydride may provide a polymer and composition containing an aromatic dianhydride and an alicyclic dianhydride. The aromatic diacid dichloride may provide a polymer and composition that is one or a mixture of two or more selected from the group consisting of terephthaloyl dichloride, isophthaloyl dichloride, 1,1′-biphenyl-4,4′-dicarbonyl dichloride, 1,4-naphthalenedicarboxylic dichloride, 2,6-naphthalenedicarboxylic dichloride, and 1,5-naphthalenedicarboxylic dichloride.

A transparent film produced using the composition may be provided.

A window cover film comprising the transparent film and a display device comprising the window cover film may be provided.

Hereinafter, the method of selecting a solvent, the polymer solution (dope solution) containing the selected solvent, and the transparent film produced using the composition according to one embodiment will be described.

Examples of the polymer contained in the composition of one embodiment comprise polyamide and polyimide, but are not limited thereto.

As a non-limiting example, one embodiment will be described using a polyimide-based polymer (comprising a polyamideimide-based polymer).

The polymer of one embodiment may be a polymer having a structural unit derived from an aromatic diamine, a dianhydride, and an aromatic diacid dichloride that contain a compound represented by the following Chemical Formula I.

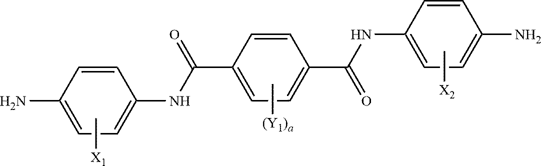

In Chemical Formula I, X₁, X₂, and Y₁ are each independently a fluoro(C1-C7)alkyl, perfluoro(C1-C7)alkyl, or fluoro group, and a is an integer from 0 to 4.

The compound of Chemical Formula I may comprise a plurality of aromatic rings to improve the mechanical strength of the film. At the same time, a fluoro substituent may be introduced into the aromatic ring to reduce a charge transfer complex (CTC) effect. In addition, a packing density in a polyamideimide structure or between chains may be reduced. Furthermore, it is possible to provide a film having remarkably improved optical properties despite having a sufficient thickness.

As the aromatic diamine according to one embodiment, two or more kinds of aromatic diamine compounds containing a compound represented by Chemical Formula I may be used. As an example, the aromatic diamine may be a mixture of two or more of compounds represented by Chemical Formula I and an aromatic diamine compound into which fluorine substituents are introduced. More specifically, the aromatic diamine may be a combination of the compound represented by Chemical Formula I and the aromatic diamine compound into which fluorine substituents are introduced.

As an example, the aromatic diamine compound into which fluorine substituents are introduced may be 2,2′-bis(trifluoromethyl)benzidine (TFMB). Such an aromatic diamine compound may induce a charge transfer effect of the fluorine substituents to provide more excellent optical properties of the film.

The dianhydride according to one embodiment may comprise an aromatic dianhydride and an alicyclic dianhydride.

As the aromatic dianhydride, for example, one or a mixture of two or more selected from the group consisting of 4,4′-(hexafluoroisopropylidene)diphthalic anhydride (6FDA), 9,9-bis(3,4-dicarboxyphenyl)fluorene dianhydride (BPAF), biphenyltetracarboxylic dianhydride (BPDA), oxydiphthalic dianhydride (ODPA), sulfonyl diphthalic anhydride (SO₂DPA), isopropylidenediphenoxy bis(phthalic anhydride) (6HDBA), 4-(2,5-dioxotetrahydrofuran-3-yl)-1,2,3,4-tetrahydronaphthalene-1,2-dicarboxylic dianhydride (TDA), 1,2,4,5-benzene tetracarboxylic dianhydride (PMDA), and benzophenone tetracarboxylic dianhydride (BTDA) may be used, but the aromatic dianhydride is not limited thereto.

Specifically, the aromatic dianhydride may be a fluorine-based aromatic dianhydride compound, and may be, for example, 4,4′-(hexafluoroisopropylidene)diphthalic anhydride (6FDA), 9,9-bis(3,4-dicarboxyphenyl)fluorene dianhydride (BPAF), or a mixture thereof. More specifically, 4,4′-(hexafluoroisopropylidene)diphthalic anhydride (6FDA) may be used. By using the fluorine-based aromatic dianhydride compound, mechanical strength, in particular, a modulus of the polyamideimide film, may be more effectively improved as well as optical properties of the polyamideimide film.

As the alicyclic dianhydride, for example, one or a mixture of two or more selected from the group consisting of 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclo[2.2.2]oct-7-ene-2,3,5,6-tetracarboxylic dianhydride (BTA), bicyclooctane-2,3,5,6-tetracarboxylic dianhydride (BODA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxycyclopentane dianhydride (TMDA), and 1,2,3,4-tetracarboxycyclopentane dianhydride (TCDA) may be used, but the alicyclic dianhydride is not limited thereto. Specifically, the alicyclic dianhydride compound may be 1,2,3,4-cyclobutanetetracarboxylic dianhydride (CBDA).

As the dianhydride compound according to one embodiment, a mixture of an aromatic dianhydride and an alicyclic dianhydride may be used. For example, in a case where a mixture of 2,2-bis(3,4-dicarboxylphenyl)hexafluoropropane dianhydride (6FDA) and 1,2,3,4-cyclobutanetetracarboxylic dianhydride (CBDA) is used, when the aromatic diamine and the aromatic diacid dichloride are combined as described, the effect of simultaneously improving the mechanical properties and optical properties of the polyamideimide film may be further improved.

The aromatic diacid dichloride according to one embodiment forms an amide structure in the polymer chain, and may further improve the mechanical properties comprising a modulus in a range in which the optical properties of the film are not deteriorated.

As the aromatic diacid dichloride, one or a mixture of two or more selected from the group consisting of terephthaloyl dichloride (TPC), isophthaloyl dichloride (IPC), 1,1′-biphenyl-4,4′-dicarbonyl dichloride (BPC), 1,4-naphthalenedicarboxylic dichloride (NPC), 2,6-naphthalenedicarboxylic dichloride (NTC), and 1,5-naphthalenedicarboxylic dichloride (NEC) may be used, but the aromatic diacid dichloride is not limited thereto. Specifically, terephthaloyl dichloride (TPC) may be used as the aromatic diacid dichloride.

A content of the aromatic diacid dichloride according to one embodiment may be 50 mol to 90 mol, specifically, 60 mol to 90 mol, or 60 mol to 80 mol, with respect to 100 mol of the aromatic diamine, but is not limited thereto.

In a case where the aromatic diacid dichloride in the above range is used in combination with other monomers, the optical properties and mechanical strength of the polyamideimide film may be further improved. Specifically, a high light transmittance and a low haze may be implemented.

In general, when the content of terephthaloyl dichloride (TPC) is 50 mol or more with respect to 100 mol of a typical aromatic diamine, although mechanical properties of the film, such as a modulus, may be significantly improved, an intermolecular density is increased, which may cause deterioration of optical properties such as a yellow index and a haze.

However, in one embodiment, the monomer combination is used as described above, such that a phenomenon in which the optical properties of the polyamideimide film are deteriorated may be prevented even when the content of TPC is 50 mol or more with respect to 100 mol of the aromatic diamine. That is, it is possible to provide a film that simultaneously satisfies excellent optical and mechanical properties as desired.

A thickness of the polyimide-based film according to one embodiment may be, for example, 10 to 500 µm, 10 to 300 µm, 20 to 100 µm, or 30 to 100 µm.

Hereinafter, the selecting of the solvent of one embodiment will be described with reference to Examples and Comparative Examples. The following Examples and Comparative Examples are provided to assist those skilled in the art in understanding the present disclosure, and the present disclosure is not limited thereto.

First, methods for measuring physical properties of the following Examples and Comparative Examples are as follows.

### Haze Measurement

A haze was measured in accordance with the ASTM D1003 standard using a spectrophotometer (COH-5500, manufactured by Nippon Denshoku Industries Co., Ltd.). A unit of the haze is %.

### Long-Term Storage Stability Test

Immediately after mixing and dissolving 11.5 wt% of the polymer of one of Examples and 88.5 wt% of the selected solvent as a polymerization solvent for the polymer of one of Examples, when 1 to 26 days passed after dissolution, a change in transparency of the polymer solution was qualitatively evaluated.

A case where the transparency of the polymer solution is maintained as it is means that the miscibility of the polymer solution is maintained and thus aggregation of the polymer does not occur even after long-term storage, and a case where the polymer solution becomes turbid means that long-term storage of the polymer solution is deteriorated.

### Example 1

Under a nitrogen atmosphere, 2,2′-bis(trifluoromethyl)benzidine (TFMB) and DMAc selected from about 1,400 kinds of solvents selected as polymerization solvents for a polymer were added to a reactor, stirring was sufficiently performed, terephthaloyl dichloride (TPC) was added, and then the mixture was stirred at room temperature (25° C.) for 6 hours to dissolve and react the mixture. Thereafter, the reaction product obtained by precipitation and filtration using an excessive amount of methanol was vacuum dried at 50° C. for 6 hours or longer to obtain a polyamide oligomer having a number average molecular weight of 1,700 g/mol.

Under a nitrogen atmosphere, DMAc, the polyamide oligomer, additional TFMB, and an aromatic diamine compound 1 represented by Chemical Formula I were added again so that a molar ratio of TFMB:diamine compound 1 was 70:30. Thereafter, 1,2,3,4-cyclobutanetetracarboxylic dianhydride (CBDA) and 4,4′-(hexafluoroisopropylidene)diphthalic anhydride (6FDA) were sequentially added so that a molar ratio of TFMB:diamine compound 1:TPC:6FDA:CBDA was 70:30:55:15:30 in terms of the total amount of the monomers used. A polyamideimide precursor solution was prepared by dissolving and reacting the mixed solution under stirring at 40° C. for 12 hours.

Subsequently, pyridine and acetic anhydride were sequentially added to the polyamideimide precursor solution at 2.5 mol times the total dianhydride content, respectively, and then the mixture was stirred at 60° C. for 12 hours, thereby preparing a composition containing a polyamideimide resin (a composition for forming a polyamideimide film).

Solution casting was performed on the composition for forming a polyamideimide film of Example 1 on a glass substrate using an applicator. Thereafter, the composition was subjected to a heat treatment in a vacuum oven at 100° C. for 30 minutes, 200° C. for 30 minutes, and 300° C. for 30 minutes, and then the composition was cooled at room temperature. Thereafter, the film formed on the glass substrate was separated from the substrate to obtain a polyamideimide film having a thickness of 50 µm of Example 1.

A haze of the polyamideimide film was 1.2%.

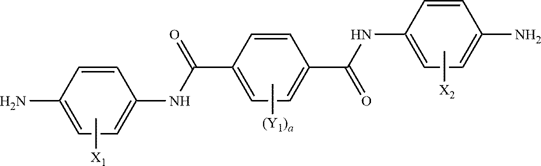

In Chemical Formula I, X₁, X₂, and Y₁ are each independently a fluoro(C1-C7)alkyl, perfluoro(C1-C7)alkyl, or fluoro group, and a is an integer from 0 to 4.

A result of calculating the value of (ΔΔµ)*/(amide bond ratio) of each solvent for the polymer of Example 1 using software is shown in Table 1. The results of evaluating the long-term storage stabilities of the polymer solutions among the solvents having difference values of (ΔΔµ)*/(amide bond ratio) are shown in Table 2.

TABLE 2

| | Example 1 | | Example 2 | | Example 3 | | Comparative Example 1 | | Comparative Example 2 | | Comparative Example 3 | | Comparative Example 4 | |
|---|---|---|---|---|---|---|---|---|---|---|---|---|---|---|
| | Dimethylac etamide (DMA_{C}) | | Dimethylprop ionamide (DMPA) | | Diethylformam ide (DEF) | | Dimethylforma mide (DMF) | | Hexane | | Methanol | | Diethyl ether | |
| Δµ* | 11.86 | | 11.92 | | 11.89 | | 11.37 | | -7.43 | | 4.31 | | 9.34 | |
| (ΔΔµ) */ (a mide bond ratio) | 1.84 | | 2.08 | | 1.93 | | 1.61 | | -1.20 | | 0.42 | | 1.13 | |
| Haze (%) | 1.2 | | 0.5 | | 1.0 | | 1.4 | | * | | | | | |
| Standing time | Immedi ately after dissol ution | 1 to 5 days | Immediat ely after dissolut ion | 1 to 5 days | Immediat ely after dissolut ion | 1 to 5 days | Immediat ely after dissolut ion | 1 to 5 days | Immediat ely after dissolut ion | 1 to 5 da ys | Immediat ely after dissolut ion | 1 to 5 da ys | Immediat ely after dissolut ion | 1 to 5 da ys |
| Solubilit y | o | o | o | o | o | o | Δ | × | × | × | × | × | × | × |

o: Soluble, Δ: Partially insoluble, ×: Insoluble, *: impossible to measure because film production is not possible

In the cases of Examples 1 and 2 in which the solvent selected by the selection method of one embodiment was comprised, a transparent film having a sufficient thickness was formed.

On the other hand, in the case of Comparative Example 1 in which the polymerization solvent having a value of (ΔΔµ)*/(amide bond ratio) of less than 1.84 was used, the haze value was significantly higher than those of the polyamideimide films of Examples 1 and 2.

This phenomenon occurs because the selected polymerization solvent for the polyamideimide-based polymer of one embodiment is excellent in solubility and miscibility, and thus fine voids are not present in the film, and precipitation caused by re-aggregation of the polymer chains does not occur.

Referring to Table 2, in the case where the solvent selected according to the method of selecting a solvent of one embodiment was used for the polymerization reaction, it could be confirmed that the miscibility of the solvent and the polymer was excellent, and thus the solubility was excellent, and the solubility was maintained even after being allowed to stand for 1 to 5 days after dissolution.

That is, in the case of dimethylformamide (DMF) having a value of (ΔΔµ)*/(amide bond ratio) of less than 1.84 used as a solvent, the solubility in the polymer of one embodiment was low, and in the cases of DMAc and dimethylpropionamide (DMPA) having a value of (ΔΔµ) */(amide bond ratio) of 1.84 or more, the solubility was high.

In the case where the miscibility of the solvent and the polymer was excellent, the polymer solution was transparent, and in the case where the miscibility of the solvent and the polymer was poor, the polymer solution was turbid.

The long-term storage stability of the composition was determined according to a change in transparency of the solution after 1 to 26 days immediately after mixing the solvent selected according to the method of selecting a solvent of one embodiment and the polymer of one embodiment.

It could be appreciated that the long-term storage stability of the composition was also excellent because the solubility and the miscibility of the polymer of one embodiment and the solvent satisfying the value of (ΔΔµ)*/(amide bond ratio) of 1.84 or more were excellent. Therefore, it may be appreciated that the degree of miscibility of the polymer and the solvent affects the transparency, haze, and long-term storage stability of the film.

As set forth above, the method of selecting a polymerization solvent suitable for a process of producing a film using a composition containing a polymer may be provided.

The selection method may shorten complex experimental steps that consume a lot of time and effort, and in the case of DMAc, which is used as a transparent polymerization solvent for a polymer, it is highly likely that environmental regulations will be strengthened in the future because it is a toxic substance. Therefore, it is possible to provide a method of selecting an eco-friendly solvent, which is a non-regulated substance, while maintaining the same physical properties as those of the existing solvent.

A film produced using a composition containing the selected polymerization solvent may have excellent transparency.

When the transparent film produced using the composition containing the selected polymerization solvent is applied to a window hard coating layer, a transparent film having a high light transmittance throughout the visible light region and having a low haze may be provided.

In addition, the polymer solution of one embodiment may provide significantly excellent physical properties of a film, in particular, when used for an optical film, because the transparency of the polymer solution is maintained even during long-term transportation and storage, and turbidity does not occur.

Through the selecting of the polymerization solvent for a polymer by [Equation 1] indicating the predicted value of solubility between the polymer and the solvent according to one embodiment, when a dope solution is prepared using the solvent selected by the selection as a solvent for the polymer to produce a film, a transparent film having more excellent transparency and a low haze may be provided.

When a solvent having (ΔΔµ)*/(amide bond ratio) of 1.8 or more is selected, the solvent may be significantly excellent for use in optical applications because dissolution stability of the solution is achieved. Further, the dope solution (polymer solution) obtained using the solvent selected by the above method may reduce the time and effort to provide a film having significantly excellent long-term storage stability and excellent physical properties, and may provide a product having the best physical properties of the film. A solvent having excellent miscibility with the polymer of one embodiment may be accurately predicted through the selection. A composition containing the selected polymerization solvent may have excellent long-term storage stability.

Therefore, the spirit of the present disclosure should not be limited to the described embodiments, but the claims and all modifications equal or equivalent to the claims are intended to fall within the spirit of the present disclosure.

1. A method of preparing a composition for producing a transparent film that contains a polymer, and a polymerization solvent for the polymer, the method comprising selecting a polymerization solvent for the polymer,
wherein the selecting of the polymerization solvent satisfies all of the following conditions (1) to (4):
(1) the polymerization solvent for the polymer is selected by the following [Equation 1],
(2) an amide bond ratio in [Equation 1] is less than 1.0,
(3) the solvent selected in (1) has a value that is calculated by [Equation 1] and is equal to or greater than a reference value, and
(4) the reference value is a value of [Equation 1] when DMAc is used as the polymerization solvent of the polymer,
$$\left(Δ Δ μ\right) * / \left(\text{amide bond ration}\right) = \left\{\left(Δ Δ {μ}_{\text{ir}}\right) / Δ \text{r}\right\} *$$
in Equation 1,
Δµ is a difference in pseudo-chemical potential of the polymer dissolved in the solvent,
Δµᵢᵣ means Δµ of a polymer i having an amide bond ratio r,
Δr means a difference in amide bond ratio between two or more kinds of amide bonds,
( ΔΔµᵢᵣ ) / Δr means ΔΔµᵢᵣ which is a difference in Δµᵢᵣ according to the difference in amide bond ratio, and
{ ( ΔΔµᵢᵣ ) / Δr } * is a standardized value of ( ΔΔµᵢᵣ ) / Δr.

2. The method of claim 1, wherein in [Equation 1], Δµ is a value calculated using the COSMO-RS theory.

3. A composition for producing a transparent film, the composition comprising:
a polymer; and
a polymerization solvent for the polymer,
wherein the polymerization solvent satisfies all of the following conditions (1) to (4):
(1) the polymerization solvent for the polymer is selected by the following [Equation 1],
(2) an amide bond ratio in [Equation 1] is less than 1.0,
(3) the solvent selected in (1) has a value that is calculated by [Equation 1] and is equal to or greater than a reference value, and
(4) the reference value is a value of [Equation 1] when DMAc is used as the polymerization solvent of the polymer,
$$\left(Δ Δ μ\right) * / \left(\text{amide bond ratio}\right) = \left\{\left(Δ Δ {μ}_{\text{ir}}\right) / \text{Δ} \text{r}\right\} *$$
in Equation 1,
Δµ is a difference in pseudo-chemical potential of the polymer dissolved in the solvent,
Δµᵢᵣ means Δµ of a polymer i having an amide bond ratio r,
Δr means a difference in amide bond ratio between two or more kinds of amide bonds,
( ΔΔµᵢᵣ ) / Δr means ΔΔµᵢᵣ which is a difference in Δµᵢᵣ according to the difference in amide bond ratio, and
{ ( ΔΔµᵢᵣ ) / Δr } * is a standardized value of ( ΔΔµᵢᵣ ) / Δr.

4. The composition of claim 3, wherein in [Equation 1], Δµ is a value calculated using the COSMO-RS theory.

5. The composition of claim 3, wherein the polymer is a polyamideimide-based polymer.

6. The composition of claim 3, wherein the polymer has a structural unit derived from one or two or more selected from the group consisting of an aromatic diamine, a dianhydride, and an aromatic diacid dichloride.

7. The composition of claim 6, wherein the aromatic diamine comprises 2,2′-bis(trifluoromethyl)benzidine.

8. The composition of claim 6, wherein the dianhydride comprises an aromatic dianhydride and an alicyclic dianhydride.

9. The composition of claim 6, wherein the aromatic diacid dichloride is one or a mixture of two or more selected from the group consisting of terephthaloyl dichloride, isophthaloyl dichloride, 1,1′-biphenyl-4,4′-dicarbonyl dichloride, 1,4-naphthalenedicarboxylic dichloride, 2,6-naphthalenedicarboxylic dichloride, and 1,5-naphthalenedicarboxylic dichloride.

10. A transparent film produced using the composition for producing a transparent film of claim 3.

11. A window cover film comprising the transparent film of claim 10.

12. A display device comprising the window cover film of claim 11.
